(19) United States
(12) Patent Application Publication
(10) Pub. No.: US 2012/0082827 A1
(43) Pub. Date: Apr. 5, 2012

(54) WOOD FILM AND METHOD OF MOLDING THE SAME

(75) Inventors: Ah Hyun Bae, Hwaseong-si (KR); Sang Ik Son, Suwon-si (KR); Jae Chul Jin, Hwaseong-si (KR); Seok Hyun Hong, Seoul (KR); Hoon Soo Park, Seongnam-si (KR)

(73) Assignee: SAMSUNG ELECTRONICS CO., LTD., Suwon-si (KR)

(21) Appl. No.: 13/180,901

(22) Filed: Jul. 12, 2011

(30) Foreign Application Priority Data
Oct. 4, 2010 (KR) 10-2010-0096357

(51) Int. Cl. B32B 21/10; B29C 45/14; B32B 38/10

(52) U.S. Cl. 428/196; 156/154; 264/257

(57) ABSTRACT

According to an example embodiment, a wood film includes a patterned wood film, a non-woven fabric attached to a surface of the patterned wood film, and a resin film attached to a surface of the non-woven fabric. According to an example embodiment, a method of molding a wood film includes attaching a non-woven fabric to a first surface of a patterned wood film, attaching a resin film to a surface of the non-woven fabric, grinding a second surface of the patterned wood film to reduce a thickness of the patterned wood film to form the wood film, and molding a portion of the wood film into a desired shape by pressing and heating the wood film using a press mold. The second surface of the patterned wood film is opposite to the first surface of the patterned wood film.

### CROSS-REFERENCE TO RELATED APPLICATION

This application claims priority under 35 U.S.C. §119 to Korean Patent Application No. 2010-0096357, filed on Oct. 4, 2010 in the Korean Intellectual Property Office, the entire disclosure of which is incorporated herein by reference.

### BACKGROUND

1. Field

Example embodiments relate to a wood film and a method of molding the same.

2. Description of the Related Art

Recently, design as well as performance of electronic appliances has attracted considerable attention. Thus, the material of a case defining the external appearance of an electronic appliance has become an important factor in determining market penetration.

In general, resins have been widely used in cases of electronic appliances in consideration of productivity and durability. Wood cases of electronic appliances have recently been proposed to satisfy the varying tastes of customers.

However, since fabrication of wood cases of electronic appliances may entail a great number of manual processes, the wood cases may be difficult to fabricate by an automated process and thus, may be unsuitable for mass production.

### SUMMARY

According to an example embodiment, a wood film includes a patterned wood film, a non-woven fabric attached to a surface of the patterned wood film, and a resin film attached to a surface of the non-woven fabric.

According to an example embodiment, the non-woven fabric is attached to the patterned wood film by a urethane-based adhesive.

According to an example embodiment, the resin film includes a polycarbonate film.

According to an example embodiment, the resin film is attached to the surface of the non-woven fabric by a moisture-curable polyurethane adhesive.

According to an example embodiment, a method of molding a wood film includes attaching a non-woven fabric to a first surface of a patterned wood film, attaching a resin film to a surface of the non-woven fabric, grinding a second surface of the patterned wood film to reduce a thickness of the patterned wood film to form the wood film, and molding a portion of the wood film into a desired shape by pressing and heating the wood film using a press mold. The second surface of the patterned wood film is opposite to the first surface of the patterned wood film.

According to an example embodiment, the method further includes trimming the molded portion of the wood film.

According to an example embodiment, the method further includes forming an electronic appliance case of resin on a first surface of the resin film of the trimmed wood film by insert injection. The first surface of the resin film is opposite to the non-woven fabric.

According to an example embodiment, the method further includes attaching the non-woven fabric to the patterned wood film by a urethane-based adhesive.

According to an example embodiment, the method further includes providing the resin film including a polycarbonate film.

According to an example embodiment, the method further includes attaching the resin film to the surface of the non-woven fabric by a moisture-curable polyurethane adhesive.

### BRIEF DESCRIPTION OF THE DRAWINGS

The above and other features and advantages will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIGS. 1 and 2 are sectional views of a wood film according to an example embodiment;

FIGS. 3 to 5 are schematic views illustrating a method of molding a wood film using a press mold according to an example embodiment;

FIG. 6 is a perspective view of a wood film, a portion of which is deformed/molded into a desired shape by a press mold;

FIG. 7 is a perspective view of the deformed/molded wood film after a portion thereof is cut by trimming; and

FIG. 8 is a schematic view illustrating an injection molding process in which the cut wood film of FIG. 7 is inserted into an injection mold.

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

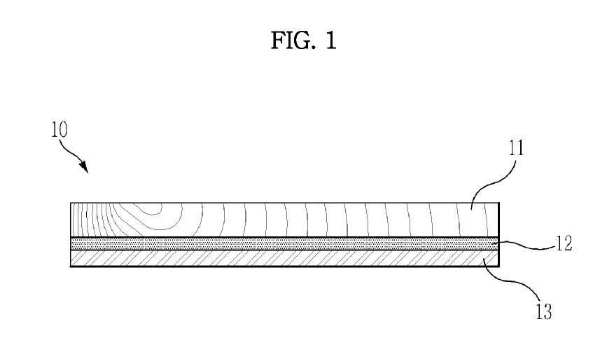

As illustrated in FIG. 1, the wood film 10 according to an example embodiment includes a patterned film 11 made of wood.

The patterned wood film 11 may be damaged by a small force if the thickness of the patterned wood film 11 is a less than a specific value, thus making handling thereof difficult. Thus, although it is necessary to provide the patterned wood film 11 with more than a desired thickness, the thick patterned wood film 11 may have poor flexibility, thus causing molding of the wood film relatively difficult.

Accordingly, the wood film 10 includes a non-woven fabric 12 attached to a rear surface of the patterned wood film 11. The non-woven fabric 12 is attached to the patterned wood film 11 by use of a urethane-based adhesive. The non-woven fabric 12 attached to the rear surface of the patterned wood film 11 serves to reinforce the patterned wood film 11, preventing the patterned wood film 11 from being damaged during a process of forming the wood film 10.

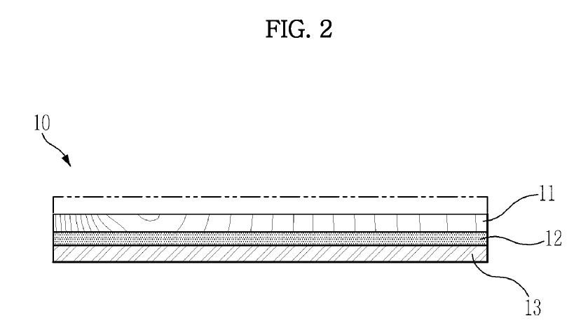

After attaching the non-woven fabric 12 to the rear surface of the patterned wood film 11 having more than the desired thickness, the patterned wood film 11 is subjected to grinding so as to reduce the thickness, as illustrated in FIG. 2. In this way, the wood film 10 having a desired flexibility and specific strength may be achieved.

The wood film 10 includes a resin film 13 attached to a rear surface of the non-woven fabric 12. The resin film 13 serves to keep the wood film 10 in a desired or defined shape. In an example embodiment, the resin film 13 is made of polycarbonate considering attaching to an electronic appliance case, and is attached to the rear surface of the non-woven fabric 12 by use of moisture-curable polyurethane.

When the wood film 10 includes the patterned wood film 11, the non-woven fabric 12 and the resin film 13 as described above, it may be possible to prevent the patterned wood film 11 from being damaged during molding and to mold the wood film 10 into a desired shape with relative ease.

Hereinafter, a method of molding the wood film 10 having the above-described configuration into a desired shape will be described.

First, the non-woven fabric 12 is attached to the rear surface of the patterned wood film 11 by use of the urethane-based adhesive and then, the resin film 13 is attached to the rear surface of the non-woven fabric 12 by use of the moisture-curable polyurethane adhesive, obtaining the wood film 10 as illustrated in FIG. 1.

Next, the patterned wood film 11 defining a front surface of the wood film 10 is subjected to grinding and/or sanding to reduce a thickness of the wood film 10, as illustrated in FIG. 2. As described above, since the non-woven fabric 12 is attached to the rear surface of the patterned wood film 11 to reinforce the patterned wood film 11, it may be possible to prevent damage to the patterned wood film 11 when an external force is applied to the patterned wood film 11 during sanding and/or grinding.

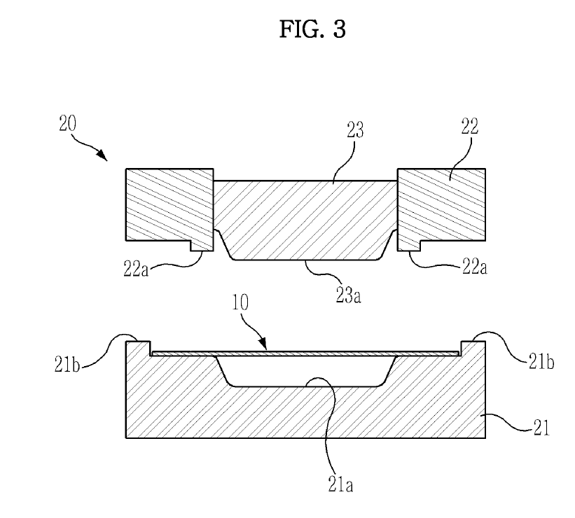

Reducing the thickness of the patterned wood film 11 by grinding may increase flexibility of the patterned wood film 11. Thus, the patterned wood film 11 may not be damaged when the wood film 10 is molded using a press mold 20 as illustrated in FIG. 3.

The press mold 20, which is used to mold the wood film 10, includes a first press mold 21 and a second press mold 23. The first press mold 21, a position of which is fixed, includes a first press mold surface 21a recessed to correspond to a desired deformed shape of the wood film 10. The second press mold 23 is installed to be reciprocally movable toward or away from the first press mold 21. The second press mold 23 includes a second press mold surface 23a convexly formed to correspond to the recessed first press mold surface 21 a. As will be apparent, the shapes of the first press mold surface 21a and the second press mold surface 23a are a design choice.

The press mold 20 further includes a supporting mold 22, which is reciprocally movable toward or away from the first press mold 21 so as to selectively support the wood film 10 on the first press mold 21 according to a position thereof. The first press mold 21 includes a first supporting portion 21b protruding toward the supporting mold 22 to keep a desired distance between the first press mold 21 and the supporting mold 22. The supporting mold 22 includes a second supporting portion 22a protruding toward a portion of the first press mold 21 adjacent to the recessed first press mold surface 21a. In a state in which the supporting mold 22 and the first press mold 21 are supported by each other to keep a desired distance therebetween by the first supporting portion 21b, the second supporting portion 22a movably supports an outer rim portion of the wood film 10.

In an example embodiment, the second press mold 23 is reciprocally movably mounted on the supporting mold 22 so as to protrude from the supporting mold 22. Thus, the second press mold 23 may be reciprocally moved along with the supporting mold 22, or may be moved independently of the supporting mold 22 so as to further protrude from the supporting mold 22.

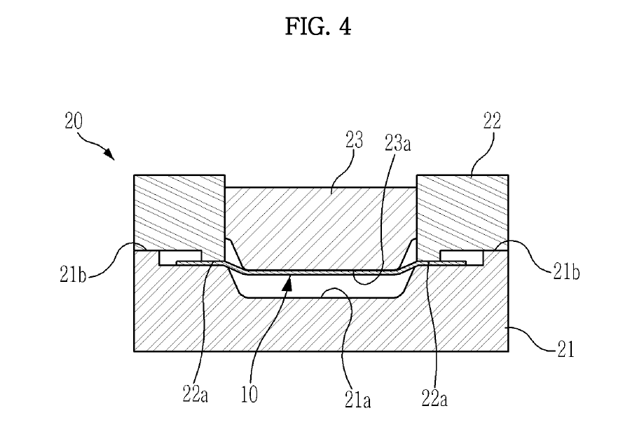

If the supporting mold 22 is moved toward the first press mold 21 after the wood film 10 is placed on the first press mold 21 to cover the recessed first press mold surface 21a, the second press mold 23 mounted on the supporting mold 22 so as to protrude from the supporting mold 22 is moved along with the supporting mold 22 as illustrated in FIG. 4. Thereby, the second press mold surface 23a of the second press mold 23 is moved into the recessed first press mold surface 21 a, and acts to move a portion of the wood film 10 into the recessed first press mold surface 21a.

The supporting mold 22 is supported by the first supporting portion 21b after being moved by a desired distance, thereby being kept at a desired distance from the first press mold 21. In such a state, the outer rim portion of the wood film 10 is movably supported by the second supporting portion 22a.

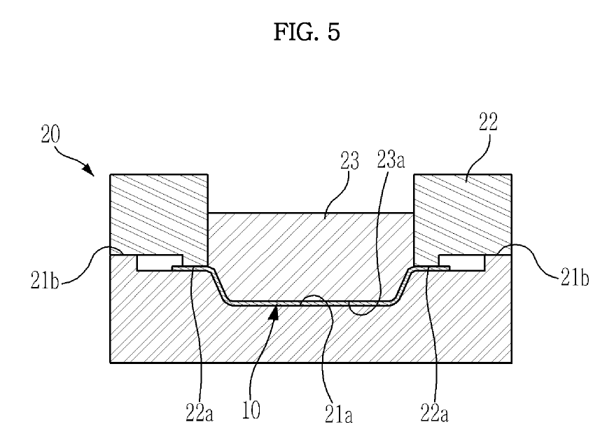

After the movement of the supporting mold 22 is completed, as illustrated in FIG. 5, the second press mold 23 is moved toward the first press mold 21 such that the second press mold surface 23a is moved more deep into the recessed first press mold surface 21a. Moving the second press mold surface 23a into the recessed first press mold surface 21a may cause extension of the wood film 10. Since the outer rim portion of the wood film 10 is movably supported by the second supporting portion 22a as described above, the outer rim portion of the wood film 10 may be partially moved into the recessed first press mold surface 21a. When the wood film 10 is extended/stretched simultaneously while being moved into the recessed first press mold surface 21 a, an extension rate of the wood film 10 is not large. Thus, it may be possible to prevent the patterned wood film 11 from being damaged during forming using the press mold 20.

Although not illustrated in the drawings, the press mold 20 may incorporate a heating device which applies heat to the wood film 10 so as to enable softening of the wood film 10, more particularly, the resin film 13 of the wood film 10.

In this way, during forming using the press mold 20, the wood film 10 may be softened so as to be extended/stretched with relative ease upon receiving heat generated from the heating device and simultaneously, may be deformed/molded into a space corresponding to a space between the first press mold surface 21a and the second press mold surface 23a.

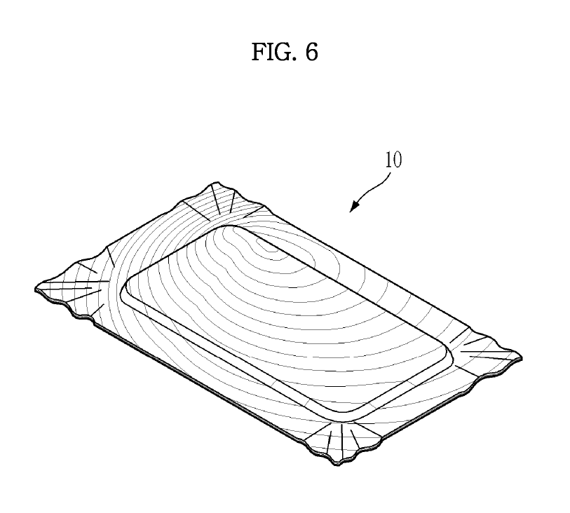

The resin film 13 of the wood film 10 is temporarily softened by heat generated from the heating device of the press mold 20 and is then hardened as the temperature drops. As the hardened resin film 13 serves to keep the wood film 10 deformed/molded, the wood film 10, a portion of which is deformed/molded into a desired shape as illustrated in FIG. 6, is completed.

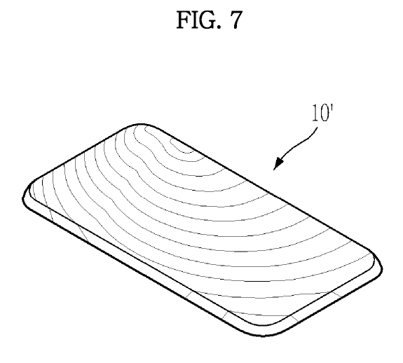

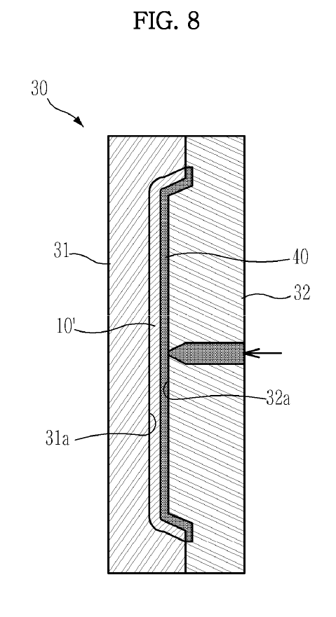

The deformed/molded portion of the wood film 10 is cut by, for example, trimming to fabricate a cut wood film 10′ as illustrated in FIG. 7. The cut wood film 10′ is inserted into an injection mold 30 as illustrated in FIG. 8, and an electronic appliance case 40 made of resin is formed at a rear surface of the cut wood film 10′ by injection molding. In this way, the electronic appliance case 40, to a surface of which the cut wood film 10′ is attached, is fabricated. In this case, since the resin film 13 is made of polycarbonate having superior attachment property with respect to a variety of resins as described above, the cut wood film 10′ is stably attached to the surface of the electronic appliance case 40.

The injection mold 30 includes a first injection mold 31 having a first injection mold surface 31a corresponding to a front surface of the cut wood film 10′, and a second injection mold 32 having a second injection mold surface 32a arranged to face the first injection mold surface 31a at a desired distance from the rear surface of the cut wood film 10′. As molten resin is injected into and cured in a space between the rear surface of the wood film 10 and the second injection mold surface 32a, the electronic appliance case 40 having a shape corresponding to the space between the rear surface of the wood film 10 and the second injection mold surface 32a is fabricated.

As is apparent from the above description, in a wood film according to an example embodiment, a non-woven fabric is attached to a rear surface of a patterned wood film to reinforce the patterned wood film. Accordingly, the patterned wood film may be ground to have a reduced thickness, achieving increased flexibility and consequently, allowing the wood film to be molded with relative ease to a shape corresponding to an outer surface of an electronic appliance case.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A wood film, comprising:
a patterned wood film;
a non-woven fabric attached to a surface of the patterned wood film; and
a resin film attached to a surface of the non-woven fabric.

2. The wood film according to claim 1, wherein the non-woven fabric is attached to the patterned wood film by a urethane-based adhesive.

3. The wood film according to claim 1, wherein the resin film includes a polycarbonate film.

4. The wood film according to claim 1, wherein the resin film is attached to the surface of the non-woven fabric by a moisture-curable polyurethane adhesive.

5. A method of molding a wood film, the method comprising:
attaching a non-woven fabric to a first surface of a patterned wood film;
attaching a resin film to a surface of the non-woven fabric;
grinding a second surface of the patterned wood film to reduce a thickness of the patterned wood film to form the wood film, the second surface being opposite to the first surface; and
molding a portion of the wood film into a desired shape by pressing and heating the wood film using a press mold.

6. The method according to claim 5, further comprising:
trimming the molded portion of the wood film.

7. The method according to claim 6, further comprising:
forming an electronic appliance case of resin on a first surface of the resin film of the trimmed wood film by insert injection, the first surface being opposite to the non-woven fabric.

8. The method according to claim 5, further comprising:
attaching the non-woven fabric to the patterned wood film by a urethane-based adhesive.

9. The method according to claim 5, further comprising:
providing the resin film including a polycarbonate film.

10. The method according to claim 5, further comprising:
attaching the resin film to the surface of the non-woven fabric by a moisture-curable polyurethane adhesive.
